(19) United States
(12) Patent Application Publication
(10) Pub. No.: US 2013/0346262 A1
(43) Pub. Date: Dec. 26, 2013

(54) SYSTEM FOR MULTI-TRACK SCHEDULING FOR A RETAIL ENVIRONMENT

(71) Applicant: Apple Inc., Cupertino, CA (US)

(72) Inventors: Erik G. Hadden, Cupertino, CA (US); Jason B. Raskin, San Jose, CA (US); Jonathan M. Van Keulen, San Jose, CA (US); Kuochun Chin, Mountain View, CA (US); Stephen M. Lottermoser, San Jose, CA (US)

(73) Assignee: Apple Inc., Cupertino, CA (US)

(21) Appl. No.: 13/975,047

(22) Filed: Aug. 23, 2013

Related U.S. Application Data
(63) Continuation-in-part of application No. 13/607,588, filed on Sep. 7, 2012.
Application No. 13/607,588 is a continuation-in-part of application No. 13/476,756, filed on May 21, 2012.
(60) Provisional application No. 61/488,696, filed on May 20, 2011.
(60) Provisional application No. 61/814,625, filed on Apr. 22, 2013.

(51) Int. Cl. G06Q 10/08

(52) U.S. Cl. CPC G06Q 10/087
USPC 705/28

(57) ABSTRACT

A system and method for generating interactive floor maps for displaying the layout of a retail store are provided. The interactive floor map can display the layout of a store based on events occurring in the future. If an event results in a change in the layout of the store, an employee of the store can preview the changes to the store as of the event date, prior to the occurrence of the event.

### CROSS-REFERENCES TO RELATED APPLICATIONS

This application is a continuation-in-part of U.S. application Ser. No. 13/607,588, filed on Sep. 7, 2012, which is a continuation-in-part of Ser. No. 13/476,756, filed on May 21, 2012, which claims the benefit under 35 USC §119(e) of U.S. Provisional Application No. 61/488,696, filed on May 20, 2011. This application also claims the benefit under 35 USC §119(e) of U.S. Provisional Patent Application No. 61/814,625, filed on Apr. 22, 2013. Each of the above-listed applications is hereby incorporated by reference in its entirety for all purposes.

### BACKGROUND

Conventionally, managing layout of a retail store and managing the product inventory of the retail store are done independent of each other. When a rearrangement of products is needed within multiple stores, e.g., due to new product launch, discontinued products, etc., there is no easy way to manage such a transition using conventional techniques.

There is a need in the art for more centralized and versatile techniques for managing operations of retail stores.

### BRIEF DESCRIPTION OF THE DRAWINGS

FIG. 1 is a high-level block diagram of a retail network 100 according to an embodiment of the present invention.

FIGS. 2A-2B illustrate an interactive floor map according to an embodiment of the present invention.

FIGS. 3A and 3B illustrate interactive floor maps for a retail store for two different dates according to an embodiment of the present invention.

FIG. 4 illustrates an interactive floor plan for a particular date according to an embodiment of the present invention.

FIG. 5 illustrates an interactive floor plan for a date different from the date in FIG. 4, according to an embodiment of the present invention.

FIG. 6 is a flow diagram of a process for generating an interactive floor map according to an embodiment of the present invention.

FIG. 7 illustrates an instance of the graphical user interface (GUI) displaying the interactive floor map according to an embodiment of the present invention.

FIG. 8 is a simplified block diagram of an employee device according to an embodiment of the present invention.

FIG. 9 is a simplified block diagram of a computer system 900 that may be used to practice embodiments of the present invention.

### DETAILED DESCRIPTION

Embodiments of the present invention are generally related to managing layout of retail stores. More specifically, certain embodiments of the present invention provide a technique for generating interactive floor maps for a retail store for events associated with the store. In some embodiments, the events may include launch of a new product being sold, reconfiguration of the retail store, etc.

Some embodiments of the present invention provide a method for generating an interactive floor map for a store. The method includes receiving information about a plurality of products being sold in the store, generating a first interactive floor map for the store, the first interactive floor map displaying a first placement of the plurality of products in the store, receiving information about one or more events associated with at least one product from the plurality of products, and generating, a second interactive floor map based on at least one event from the one or more events, wherein the second interactive floor map displays a second placement of the plurality of products in the store and wherein the second placement is different from the first placement.

Other embodiments of the present invention provide a method for managing a plurality of retail stores. The method comprises generating a first interactive floor map for each of the plurality of retail stores. The first interactive floor map specifies a first arrangement of products to be displayed in the retail store. The method further includes communicating the first interactive floor map to an in-store device or in-store server located in each of the plurality of retail stores, receiving information about an event occurring on an effective date and time a second interactive floor map for each of the plurality of retail stores generating based on the information about the event. The second interactive floor map specifies a second arrangement of the products to be displayed in the retail store as of the effective date and time. The method also includes communicating the second interactive floor map in advance of the effective date and time to the in-store device or in-store server.

A particular embodiment of the present invention provides a graphical user interface (GUI) that includes (a) a first section displaying one or more product display fixtures. The product display fixtures represent one or more products to be displayed in a retail store, (b) a second section displaying user selectable icons. The user selectable icons including an icon for displaying one or more events associated with the retail store, and (c) a third section displaying a listing of events associated with the retail store. The third section is activated upon selection of the icon. In some embodiments, the listing of events includes information about one or more products and data and time for each event associated with each of the one or more products.

Embodiments of the present invention generally relate to operation of a retail store. More specifically, certain embodiments of the present invention provide techniques for managing product placements/locations within a retail store. Other embodiments of the present invention provide techniques for managing product roll-outs across multiple retail locations and the associated changes that may be needed to the store layout of all the affected retail locations.

Typically, a large merchant such as a department store chain, a grocery store chain, etc. may have multiple retail locations spread across a large georgraphic area. In some embodiments, the geographic area can span an entire country or several continents. Each retail location may carry multiple product types and multiple products of each type. In general retail stores will have display units that display the products being offered for sale. In some retail stores, the display units themselves double as product storage and a user can pick up the desired product directly from the display unit. Such arrangement is typical in a retail grocery store. In other instances, the product display units may only display and provide information about the products being offered, while the actual product is stored separately from the display units. This may be particularly true in the instance where the product being sold is high value and/or where a specially trained person may be need to be consulted before the product is sold. Some retail stores may have a combination of both types of product arrangement styles described above.

As described above, in a retail store, products are typically arranged such that it is easy for a user to locate the product. This includes placing informational signs at various locations in the store to direct the user to the product he/she is looking for, grouping similar product types together in a location, placing signs on each display unit to provide more information about the product being displayed, etc. Every so often some of the products may no longer be available for sale at one or more retail locations due to various reasons such a discontinuation of the product by the manufacturer, a newer version of the product being released, low demand for the product, etc. In such an instance, that product is removed from display and sale from the affected retail location and the layout of the store may need to be changed in some instances to accommodate such change. Currently there is no centralized way to inform multiple retail locations that a change in layout of a retail store is needed and when a new layout for the store will become effective.

Embodiments of the present invention provide techniques for managing floor plan layouts of multiple retail stores for events that occur at some time in the future. Some embodiments also provide methods for managing time-based product availability instructions for store personnel. All of these actions can be done from a central location and information can be sent to the individual retail stores. Once the employee receives this information, he/she can be aware of the changes to be made to his/her retail store and when and how those changes are to be implemented. Each retail store worldwide can be individually and independently managed using techniques described herein.

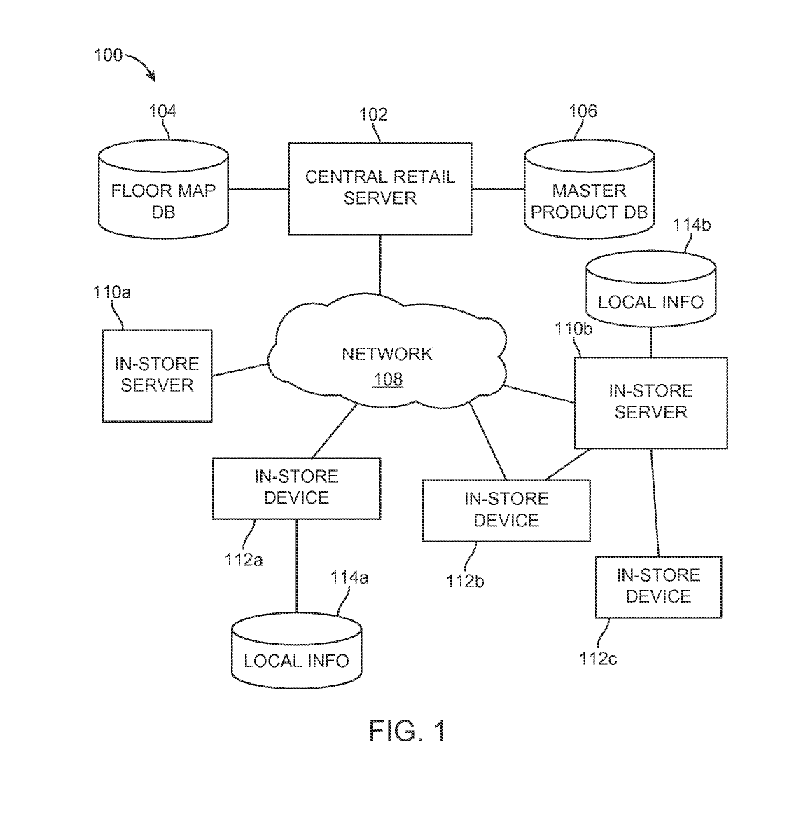

FIG. 1 is a high-level block diagram of a retail network 100 according to an embodiment of the present invention. Retail network 100 includes a central retail server 102 that is coupled to one or more in-store devices or one or more in-store servers. Central retail server 302 manages a floor map data store (DB) 104 and a master products data store 106. Floor map data store 104 can provide information about the current and planned future layout of every store within retail network 100, e.g., in the form of interactive floor maps as described below. Master product data store 106 can provide information about every product sold by stores in retail network 100. The information can include any type of information about the product. Examples include physical information (e.g., dimensions, color, and general appearance of the product); feature data (e.g., storage capacity, processor speed, network connectivity); marketing information (e.g., product brand name, current price, sale price); information about related products (e.g., accessories, other products in the same product line) and the like. The information can also include images of the product, screenshots from the product in use, video clips of the product being used, audio clips explaining product features, and so on. In some embodiments, master product data store 106 can be organized hierarchically; examples are described below.

Central retail server 102 can communicate via a network 108 (e.g., the Internet) with any number of in-store devices or in-store servers, including servers 110a, 110b, and in-store devices 112a, 112b and 112c. In-the depicted instance, in-store server 110a is located in a first store in retail network 100; in-store device 112a is located in a second store; and in-store server 110b and in-store devices 112b, 112c are located in a third store. A number of in-store devices 112, a number of in-store servers 110 and/or a number of both may be fixed (e.g., at one device) or variable across stores. In-store server 110 can communicate with one or more in-store devices 112 and/or one or more remote devices. In-store device 112 can include a device used by employees and/or by potential consumers. In some instances, in-store device 112 is associated with and to be located near a displayed product. In-store device 112 can be used to display information about the product. In some instances, in-store device 112 is used by an employee or manager to adjust a layout of the store. In-store device 112 can include an electronic device, such as a tablet, laptop, hand-held device or computer. Also as shown for in-store device 112a and in-store server 110b, an in-store device and/or in-store server can also access and/or maintain a local information store 114, which can include store-specific (“local”) information. Examples of store-specific information can include current inventory levels of various products, information about which employees are currently on duty, schedules of upcoming classes or other events offered at that store, and so on. In some embodiments, store-specific information can be managed locally or via central retail server 102, or both. For example, in-store server 110b or in-store device 112a can communicate information about current inventory levels from local information store 114b or 114a to central retail server 102, which can use this information to determine whether to ship additional products to the store associated with server 110b or in-store device 112a and/or whether to order additional products.

It will be appreciated that retail network 100 is illustrative and that variations and modifications are possible. Retail network 100 can be a regional, national, or worldwide network as desired, and can include any number of stores. In some embodiments, the network can be hierarchical, with groups of stores organized into districts, districts into regions, regions into national areas, or the like, and operations related to retail network 100 can be delegated to various levels in the hierarchy. Further, when a device is described as communicating with an in-store device, in-store server or a central retail server, such communication can be direct or indirect. For example, central retail server 102 can communicate information intended for device 112b to in-store server 110b, and in-store server 110b can communicate with device 112b to deliver the information. Additional intermediaries can be introduced if desired, and “communication” encompasses any path from sender to recipient. As described below, retail network 100 can facilitate coordination of devices across stores and in some instances within stores.

As described above, the central retail server stores floor plan details for each retail store in the retail store network. The floor plan for each retail store may include location of each product displayed in the store and/or locations for stocking some or all products offered for sale in the store. Each product being offered for sale at a retail store may have an individual availability date or “in stock” date. In some instances, the store layout may need to be changed depending on the type of product and its launch or availability date. For example, a retail store may sell one primary product and one or more secondary products (e.g., accessories) for use with the primary product. In the instance where a new version of the primary product is to be introduced, the store layout may need to be changed to accommodate new version launch. However in the instance when only one of the secondary products is to be changed (e.g., due to non-availability) the store layout may not have to be changed and only the inventory and storage of that secondary product may be affected. Embodiments of the present invention provide the ability to manage product availability for each product in a store and provide a way to see or visualize potential store layout changes that may be needed as a result of product changes.

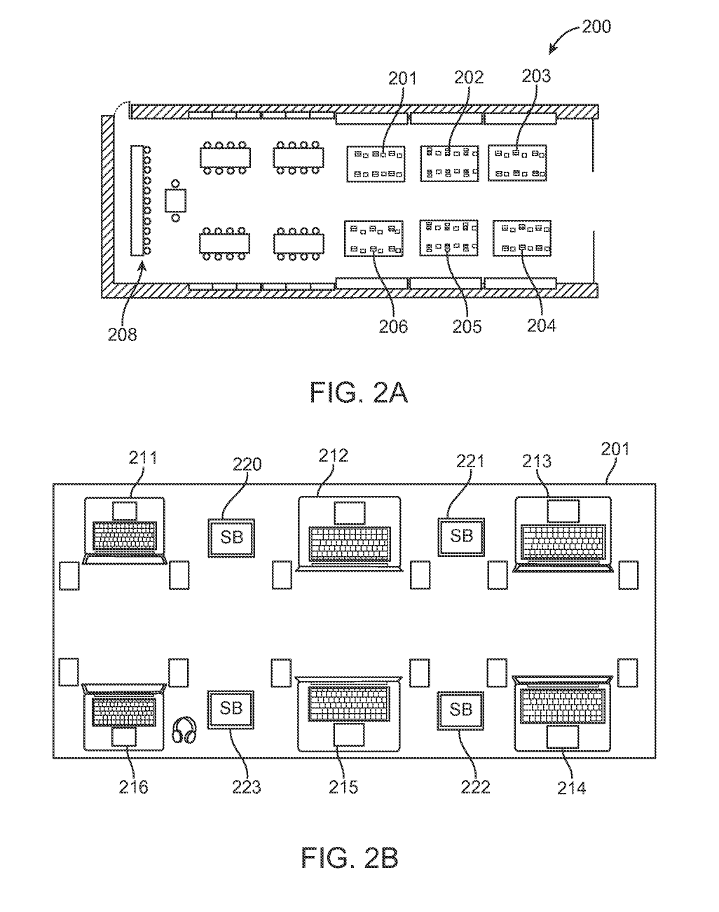

In some embodiments, the retail store layout is managed using an interactive floor map. An example of an interactive floor map (which may be referred to as a “planogram”) is illustrated in FIGS. 2A-2B. FIG. 2A shows a map 200 for a particular store. The map shows the locations of display fixtures 201-206, which are surfaces on which various products have been arranged. The map can also show other portions of the store, such as a technical support area 208. FIG. 2B shows a detail of fixture 201 from map 200. As best seen in FIG. 2B, map 200 can show the specific products 211-216 arranged on the display fixture and the positioning of dynamic signage devices 220-223. Details of designing a retail store layout are disclosed in co-pending U.S. patent application Ser. No. 13/476,756 filed on May 21, 2012 and Ser. No 13/607,588 filed on Sep. 12, 2012, the disclosures of both the applications are incorporated by reference herein in their entirety for all purposes.

In addition to the display fixtures, the interactive floor map may also provide the ability to manage storage locations for one or more products offered for sale in the store. The storage locations may be in form of traditional shelving units, hangers, or may be located underneath the display fixtures. Any traditional method for storing products in a retail store may be used to store the products being offered for sale. Product lifetime/cycle may vary significantly based on the type of products. For example, household goods such a paper towels do not change significantly and thus have a very long product lifetime/cycle. In contrast, many of the consumer electronic devices such as a camera, a mobile communication device, a tablet, a Personal Computer, etc. have a much shorter product cycle as new version of such products are constantly being released. For products having a short cycle, a retail store selling such products needs to be frequently updated to remove the old/obsolete products and add new versions of products and/or entirely new product types that never existed before.

As described above, certain products have a short cycle and may become obsolete or demand may sharply fall for these products once a newer version is released. Manufacturers of such products also reduce or cease production of older models of their products once newer versions and/or new products are released. This is particularly true of consumer electronic products and other products have a similar short life cycle. Once the older product is discontinued for sale and a newer product is launched, the retail stores selling such products are expected to carry the newer product as of the official product launch date. For example, consider that Company A is currently offering its cellular phone model “1”; however Company A plans to launch a newer version model “2” in the next six months. Upon launch of the new model “2”, the older model may be discontinued or the inventory for the older model “1” may be reduced to make room for the new model. Before the actual “on sale” date for the new model “2” the retail stores that will offer the new model for sale may need to be reconfigured so that the retail store is ready on the on-sale date to offer the new model to consumers.

Reconfiguring the retail store in anticipation of the launch of the new model may include changing the display fixtures, rearranging the display fixtures, changing the layout of the store, etc. In addition to the new model, several third party manufacturers may also offer companion products, e.g., accessories, for sale that are specifically designed to work with the new model. The retail store layout also needs to accommodate for these companion products. Each product may have a specific launch date associated with it. For example, model “2” may be released on April 5^{th} while one or more companion products may be released on April 4^{th}. Currently there is no way to simultaneously track the launch dates for multiple products and manage the retail store layout accordingly.

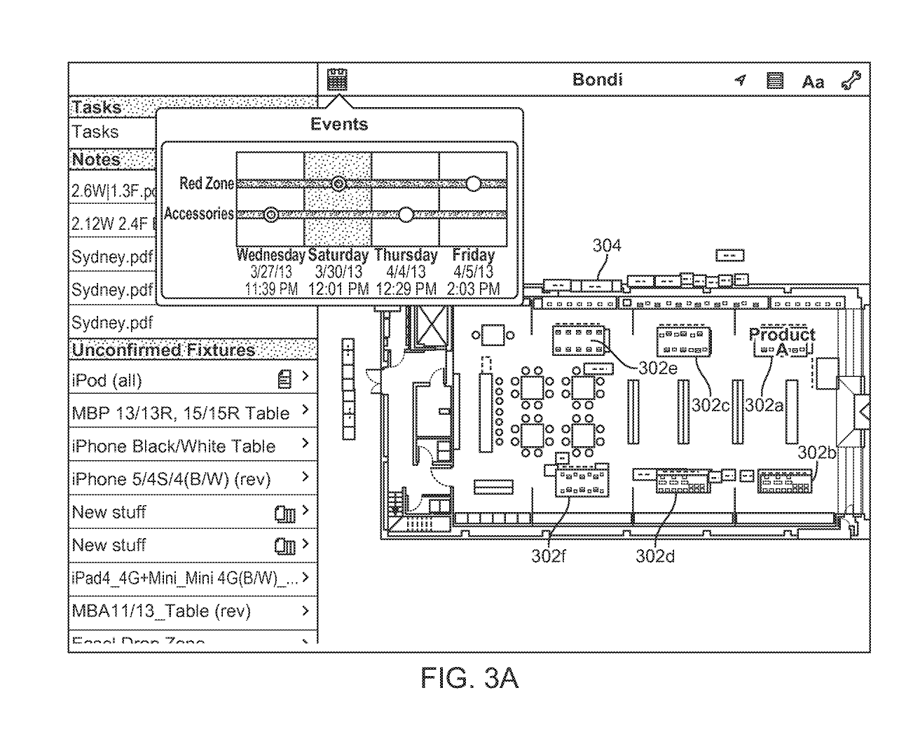

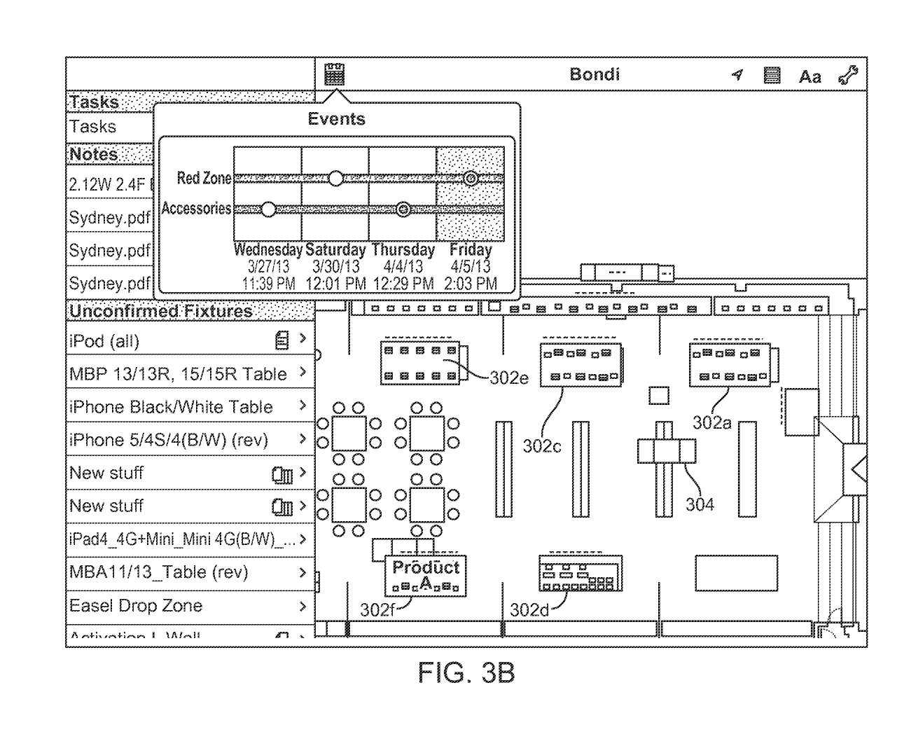

Continuing from our example from above, FIG. 3A illustrates an interactive floor plan of a retail store when the retail store is selling model “1”, according to an embodiment of the present invention. For example, FIG. 3A illustrates the layout of the retail store on March 30^{th} when model “1” is offered for sale. As described above, model “2” may be launched on April 5^{th}. Accordingly, the layout of the retail store may change as of April 5^{th}. FIG. 3B illustrates the layout of the store as of April 5^{th} according to an embodiment of the present invention. As can be seen, one or more of display fixtures 302a-f have been moved and/or eliminated, additional companion products storage locations 304 have been added, and products have been reassigned to different display fixtures than before. For example, Product A that was displayed on fixture 302a on March 30^{th} can be reassigned to be displayed on fixture 302f on April 5^{th}, fixture 302b is entirely eliminated, etc. It is to be noted that FIGS. 3A and 3B illustrate an exemplary rearrangement of retail store layout. One skilled in the art will realize that the nature and extent of change in the store layout will depend on the types of products being sold, the physical dimensions of the products and the retail store, the product life cycle, etc.

As described above, each retail store may have its own unique layout based on the area of the store, the location of the store, etc. Embodiments of the present invention provide the ability to centrally manage layouts for multiple stores and to communicate the store layouts to each individual store at any point in time. In other words, each retail store may have its unique interactive floor map, which may be indexed using the store ID or any other suitable means to establish the relationship between a retail store and its associated interactive floor map. When a new product and/or newer version/model of an existing product are to be launched, a user can generate a new floor plan for every retail store that will carry the new product/model. The new floor plan can display the layout of the retail store as of the day of the launch. Continuing our example from above, once the launch date (e.g., April 5^{th}) for model “2” is known, a user can create an interactive floor plan for a retail store reflecting the layout of the store as of April 5^{th}. Thereafter on a predetermined time and date prior to April 5^{th}, the interactive floor map can be communicated, e.g., to the in-store device or in-store server of FIG. 1. An employee of that store can view the interactive floor map on his/her employee device and can be made aware of the impending changes to the store as of April 5^{th}. This provides a centralized and a highly efficient manner of communicating changes to the individual stores, especially when the stores are spread across a vast geographical area.

Consider that at least two stores in the retail network are scheduled to carry the new model “2”. The first store A is located in the United States and the second store B is located in Australia. As described above, consider that the launch date for model “2” is April 5^{th}. Due to the time difference between Australia and the US, the product will go on sale in Australia about 15-17 hours prior to it going on sale in the US. Embodiments of the present invention provide the ability to individually schedule the dissemination of the interactive floor plans to the stores A and B based on the different time zones. The dissemination is centrally managed thus providing better control on the information and less chances of error being introduced into the floor plan data.

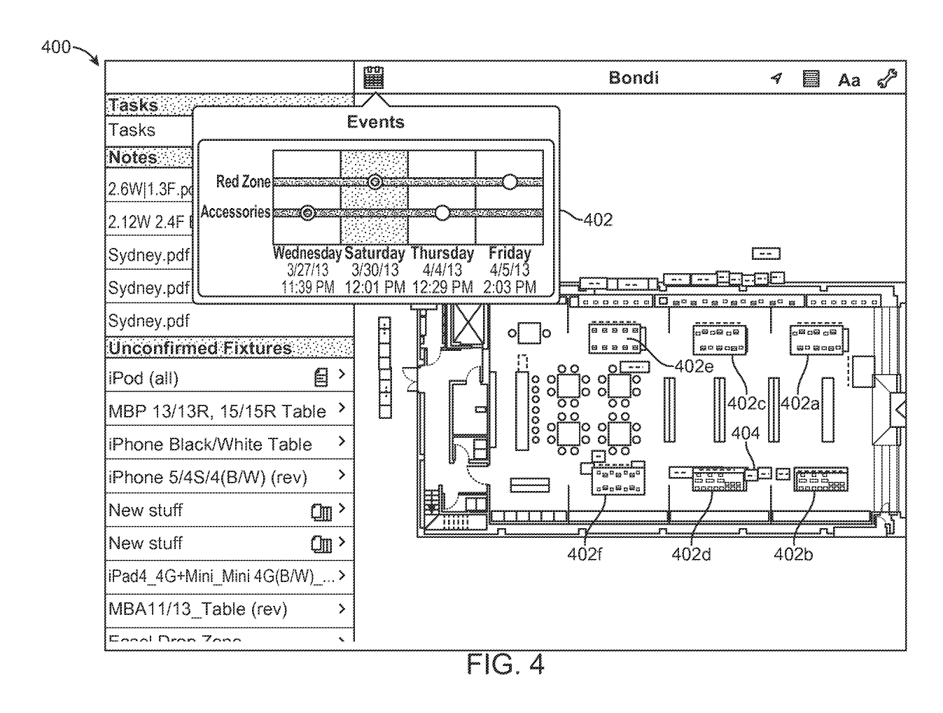

Some embodiments of the present invention provide the ability to manage roll-out of individual products within a retail store. As described above, a retail store may include numerous products. These products may be grouped according to type, class, or any other suitable grouping. For example, model “2” may have several companion products or accessories that may be offered by the manufacturer of model “2” and/or other third party manufacturers. In some instances, these companion products may be available for sale before or after the on-sale/launch date for model “2”. FIG. 4 illustrates a interactive floor plan 400 according to an embodiment of the present invention. Plan 400 can be generated centrally by a corporate-level employee as described above. Plan 400 illustrates the store layout as of March 30^{th}, which is before the launch date of model “2” in our example above. As can be seen, plan 400 tracks two different product categories, e.g., main product (i.e. red zone) and accessories. Whenever a change in floor plan 400 is needed for any reason, the change may be referred to as an ‘event.’ Each event may be tracked using the date on which that event occurs. For example, the launch of model “2” is an event that occurs on April 5^{th} and so on. An event may result in changes to the layout of the store. Of course, there may be some events where no store layout change is needed. Each product and/or product type or class may have an event associated with it. Each product and/or product type may have multiple events associated with it. Such multiple events are tracked along a timeline. FIG. 4 illustrates a pop-up box 402 that displays the details of several events associated with the main product and the accessories. For example, there are two events associated with the main product on March 30^{th} and April 5^{th} and there are two events associated with the accessory products on March 27^{th} and April 4^{th}. Each of these events may result in changes to the store layout. For example, FIG. 4 illustrates the store layout as of March 30^{th}. It can be seen that there are at least six main product display fixtures 402a-f and several accessory storage locations 404. Each of the fixtures 402a-f may be used display one or more products from the main product category or they all may display a single main product.

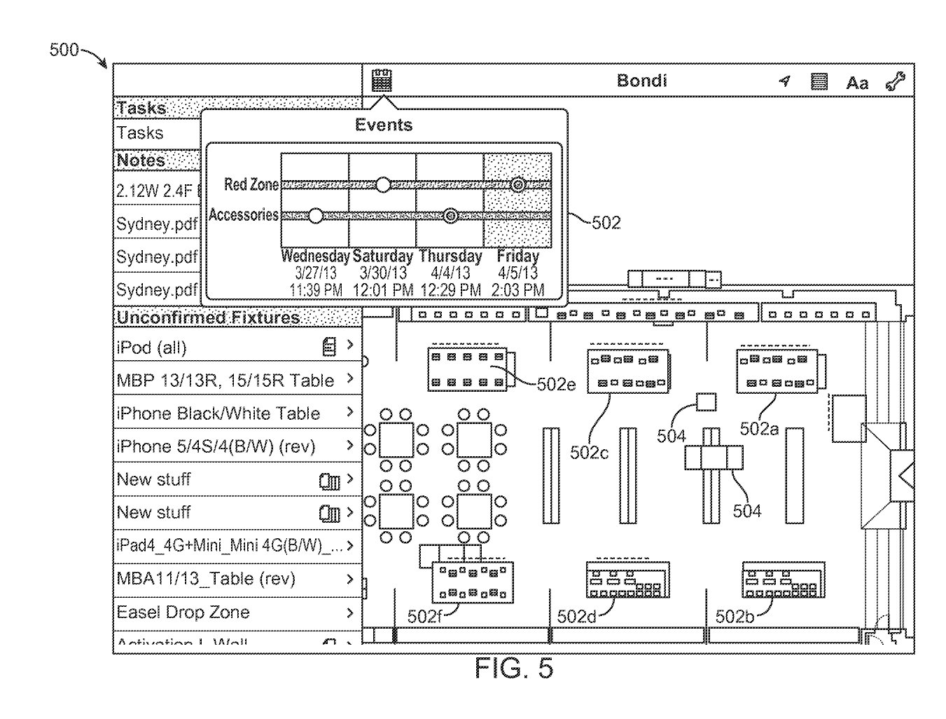

As described in the example above, consider that there is an upcoming event associated with the main product category on April 5^{th} (e.g., launch of model “2”). A new floor plan 500 as illustrated in FIG. 5 can be generated to show how the store would look as of April 5^{th}. As can be seen from FIG. 5, the appropriate event in the information box 502 is visually emphasized to indicate that floor plan 500 is for that event date. It can be seen that some accessory storage and displays 404 have been eliminated, new accessory display/storage locations 504 are added, and at least two display fixtures 402a and 402b have been designated to display the new product (e.g., model “2”). The interactive floor map provides the ability to track and visualize the store layouts associated with multiple events. Once floor map 500 is generated, it is communicated to the appropriate in-store server or in-store device. An employee using an employee device can download the interactive floor plan from the in-store server or device and interact with the floor plan as part of planning for the layout change that may be needed.

In some instances, each main product and/or companion product may have different manufacturers and release schedules. Embodiments of the present invention provide the capability for individually tracking and scheduling events for each of such main products and companion products and generating floor plan layouts associated with each event. All of this information can then be centrally tracked and managed to generate a ‘global’ view of the events for each store thereby giving the employees of the store a preview to the changes that may be needed for the store. It is to be noted that even though the events for the main product and the companion products are shown alternating with each other that need not be the case. For example, there may also be an event associated with the accessories on April 5^{th} or there may be no event at all on some days.

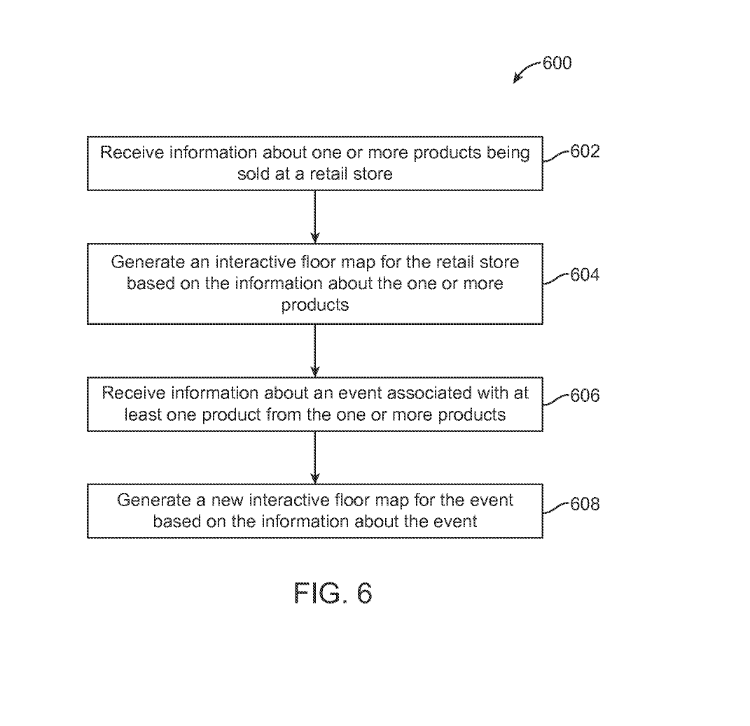

FIG. 6 is a flow diagram of a process 600 for generating an interactive floor map according to an embodiment of the present invention. Process 600 can be performed, e.g., by central retail server 102 of FIG. 1. At step 602, the central server can receive information about a plurality of products being sold in a retail store. As described above, the products can include any items being sold in the store. In some embodiments, the information about the products may include the name, model number, price, specifications, and other information related to each product being sold. In other embodiments, the central server may also receive information of the retails store where the products are being sold. Example of information about the retail store may include but is not limited to area, dimensions, shape, location, time zone, etc. of the retail store. Based on the information about the products and the information about the retail store, the central server can generate an interactive floor map at step 604. The interactive floor map may show the placement configuration for the products being sold in the store. At step 606, the central server can receive information about an event associated with one or more products being sold in the store. As described above, the event may be launch of a new product or a newer version of an existing product. The event usually may have a data and time associated with it. We can refer to this date as the ‘effective date.’ The effective date is the date on which the event will become effective. For example, if the event is the launch of a new product, then the effective date may represent the date when the new product may be available in the store.

As described above, as a result of the event, the display fixture and/or other items in the store may need to be moved, rearranged, and/or removed. This may likely change the layout of the store. At step 608, the central server may generate a new interactive floor map that specified new layout of the store based on the event. In addition, the central server may also generate correlation information linking the new interactive floor map with the event and thus to a particular date and time. This correlation information may be stored in the floor map data store described above. At any time after the new floor map in created, it may be recalled by selecting the date and/or time associated with that floor map. In some embodiments, the central server may send the new interactive floor map to an in-store server or in-store device of the retail store where it can be disseminated to the employees of the store prior to the event date. In some instances, process 600 can be modified to instead send the interactive floor map to a device or server that is remote from the store but nonetheless associated with the store. For example, the map may be sent to a device assigned to or owned by a manager of the store.

It should be appreciated that the specific steps illustrated in FIG. 6 provide a particular method of generating an interactive floor map according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. For example, in some embodiments, a moving laser beam, similar to the one described above, may be used to effect both the deposition and the anneal steps. Furthermore, additional steps may be added or removed depending on the particular applications. One of ordinary skill in the art would recognize many variations, modifications, and alternatives. In some embodiments, the time and date for sending the interactive floor map to the in-store server or to a device can be predetermined and it may be date that is prior to the date of the event. Any suitable date may be used, but in general a date that gives the employees enough time to get ready for the event may be used, e.g., about a week before the date of the event.

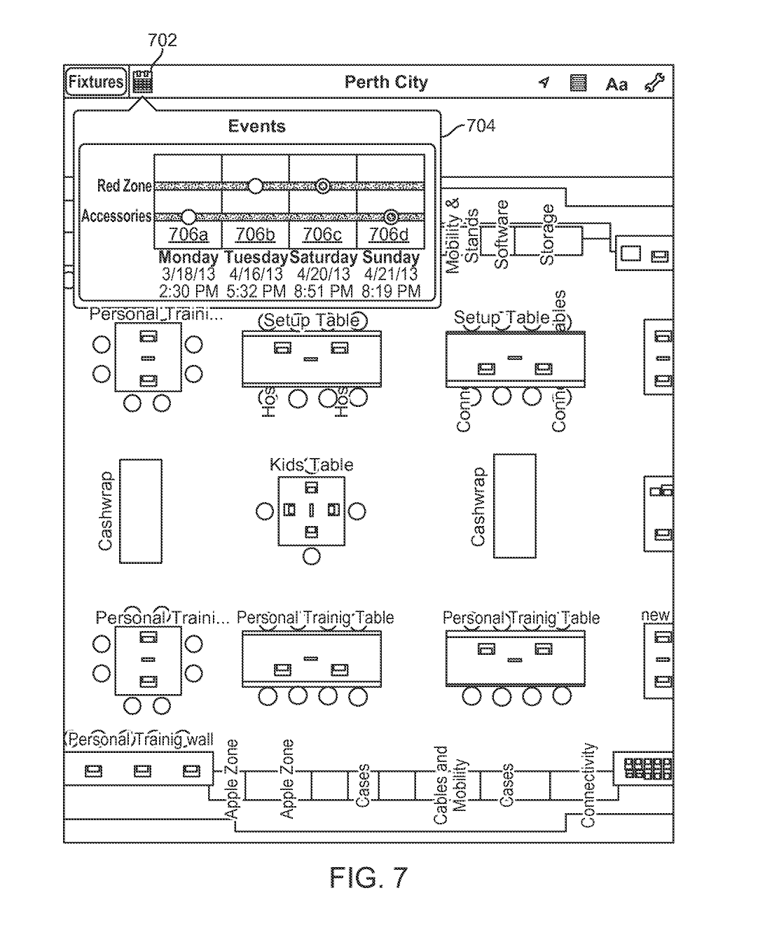

Various methods can be used to display the interactive floor map. Once the interactive floor map has been communicated to the in-store server, an employee using his employee device can download the floor map on the employee device, or the employee can view the floor map on a device directly or indirectly receiving the map. FIG. 7 illustrates an instance of the graphical user interface (GUI) displaying the interactive floor map according to an embodiment of the present invention. The GUI may include a user selectable ‘events’ icon 702. Selecting icon 702 may open up a window 704 that displays the various events associated with the various products. In one embodiment, the events are arranged by the dates on a timeline. In order to see an interactive floor map associated with a particular event, the user can select any of the selectable sections 706a-d. Each selectable section is associated with a particular date. Based on the date selected, the GUI can display the interactive floor map for the retail store as of that particular date. In this manner an employee can see one or more floor maps for events occurring at a future date and can get an understanding of the retail store layout that may be needed. As described above, each retails store may have its own unique interactive floor map. The central server communicates the appropriate floor map to the in-store server or device of the retail store.

In some embodiments, the interactive floor map may include several layers to depict different items. For example, a first layer may display all the display features and the products to be displayed on each of the display fixtures. A second layer may display products other than the products on the display fixtures, e.g., accessories or third party products, and so on. Each layer can be individually enabled/disabled for viewing.

In some embodiments, each product type may be tracked individually for any events associated with that product type. For example, a retail store may sell mobile phones, personal music players, tablet computers, laptop computers, desktop computers, and accessories for each of these product types. Each of these products may have an event associated with it. Moreover, the events for each of these product types may occur on different dates. Some of these events may result in change of the layout of the store and/or rearrangement of products. In such instances, each of the events may have an associated interactive floor map. In this manner, the retails store layout can be tracked for each event associated with each of the products. Since these events may be independent and separate from each other, this embodiment provided the ability for a store personnel to know exactly what layout to prepare for each of the events. At the planning level, it makes it easy to plan the store layout for each event and send these floor maps to the appropriate stores.

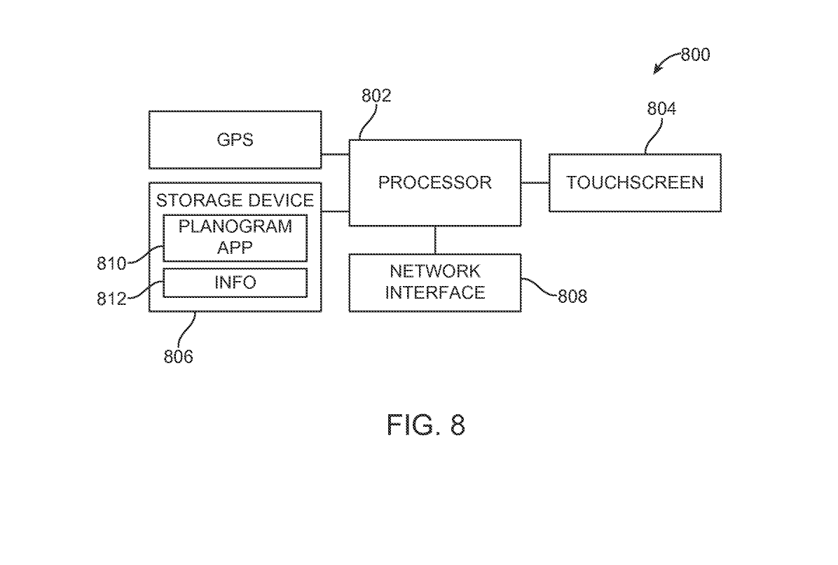

FIG. 8 is a simplified block diagram of an employee device 800 (e.g., implementing employee device 112 of FIG. 1) according to an embodiment of the present invention. Employee device 800 includes a processor 802, a touchscreen 804, a storage device 806, a network interface 808, and a Global Positioning System (GPS) module 814.

Processor 802, which can be implemented as one or more integrated circuits (e.g., a one or more single-core or multi-core microprocessors or microcontrollers, examples of which are known in the art), can control the operation of Employee device 800. In various embodiments, processor 802 can execute a variety of programs in response to program code and can maintain multiple concurrently executing programs or processes. At any given time, some or all of the program code to be executed can be resident in processor 802 and/or in storage media such as storage device 806. Through suitable programming, processor 802 can provide various functionality for employee device 800.

Touchscreen 804 can include a display device (e.g., an LCD-based display screen) with a transparent overlay that detects physical contact and generates electrical signals in response to such contact. The overlay can be segmented to allow determination of a specific area of the screen that was contacted. Conventional capacitive or resistive touchscreen technologies can be used. In some embodiments, other user interfaces capable of receiving input from a user and presenting outputs to a user can be provided in addition to or instead of touchscreen 804.

Storage device 806 can be implemented, e.g., using disk, flash memory, or any other non-volatile storage medium or combination of media. In some embodiments, storage device 806 can store programs, including operating-system and application programs that can be executed by processor 802, as well as data associated with the programs and/or other data. In the embodiment shown, storage device 806 stores an planogram application program 810 and associated information 812. Planogram application program 810 can include code that, when executed by processor 802, causes employee device 800 to update and display a current interactive floor map for the store.

Network interface 808 can provide data communication capability for employee device 800. In some embodiments network interface 808 can include radio frequency (RF) transceiver components for accessing wireless voice and/or data networks, such as Wi-Fi networks (IEEE 802.11 family standards), Bluetooth networks; cellular data networks (e.g., EDGE, 3G, 4G, or the like); or any combination thereof. In some embodiments network interface 818 can provide wired network connectivity (e.g., Ethernet) in addition to or instead of a wireless interface. Network interface 808 can be implemented using a combination of hardware (e.g., antennas, modulators/demodulators, encoders/decoders, and other analog and/or digital signal processing circuits) and software components. As described below, in some embodiments, network interface 808 allows employee device 800 to communicate with a local (e.g., in-store) network and/or a larger network encompassing multiple stores connected via Internet or the like. In some embodiments, larger inter-store networks can be implemented, e.g., using Virtual Private Networks (VPN) or other technology that supports secure communication over the Internet.

GPS module 814 can be configured to receive signals from Global Positioning System satellites orbiting Earth and to determine a location (e.g., latitude and longitude) based on signals received from the satellites. Conventional techniques can be used. In some embodiments, GPS module 814 can be used in determining the location and/or associated products for employee device 800.

It will be appreciated that employee device 800 is illustrative and that variations and modifications are possible. In some embodiments, employee device 800 can be implemented by installing appropriate software on a consumer electronic device such as a tablet computer. In other embodiments, employee device 800 can be a purpose-built device.

It will be appreciated that the system configurations and components described herein are illustrative and that variations and modifications are possible. For example, some embodiments need not include GPS module 814. Further, while employee device 800 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

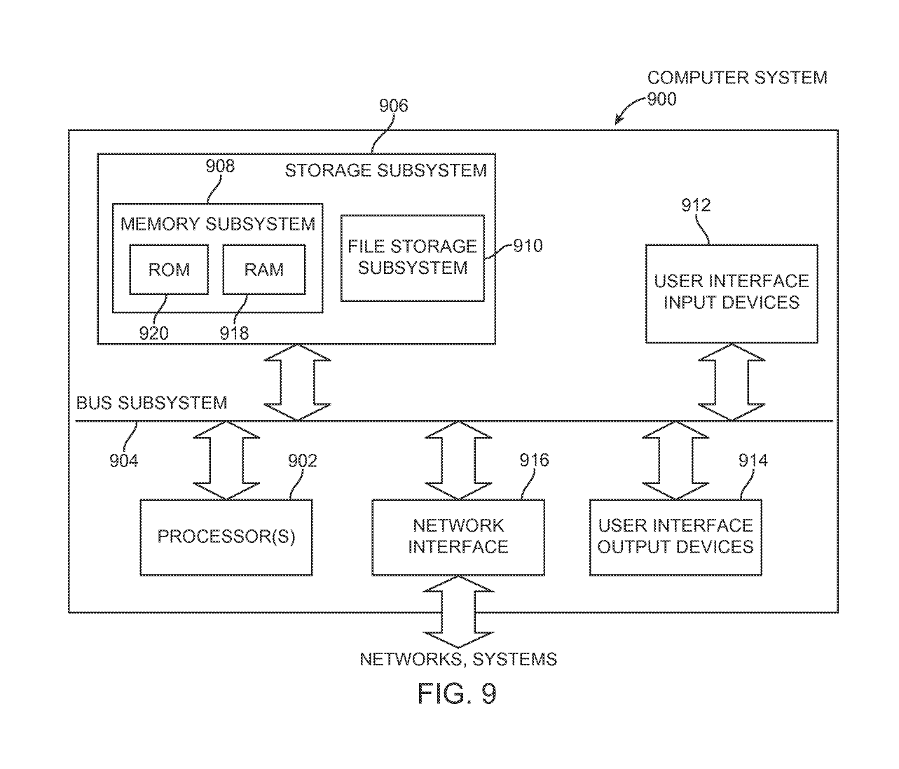

FIG. 9 is a simplified block diagram of a computer system 900 that may be used to practice an embodiment of the present invention. In various embodiments, computer system 900 may be used to implement any of the systems illustrated in FIG. 1 and described above. For example, computer system 900 may be used to implement central server 102, in-store server 110, in-store device 112 and/or a remote device in communication with in-store server. As shown in FIG. 9, computer system 900 includes a processor 902 that communicates with a number of peripheral subsystems via a bus subsystem 904. These peripheral subsystems may include a storage subsystem 906, comprising a memory subsystem 908 and a file storage subsystem 910, user interface input devices 912, user interface output devices 914, and a network interface subsystem 916.

Bus subsystem 904 provides a mechanism for enabling the various components and subsystems of computer system 900 to communicate with each other as intended. Although bus subsystem 904 is shown schematically as a single bus, alternative embodiments of the bus subsystem may utilize multiple busses.

Network interface subsystem 916 provides an interface to other computer systems and networks. Network interface subsystem 916 serves as an interface for receiving data from and transmitting data to other systems from computer system 900. For example, network interface subsystem 916 may enable a user computer to connect to the Internet and facilitate communications using the Internet.

User interface input devices 912 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 900.

User interface output devices 914 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 900.

Storage subsystem 906 provides a computer-readable storage medium for storing the basic programming and data constructs that provide the functionality of the present invention. Software (programs, code modules, instructions) that when executed by a processor provide the functionality of the present invention may be stored in storage subsystem 906. These software modules or instructions may be executed by processor(s) 902. Storage subsystem 906 may also provide a repository for storing data used in accordance with the present invention. Storage subsystem 906 may comprise memory subsystem 908 and file/disk storage subsystem 910.

Memory subsystem 908 may include a number of memories including a main random access memory (RAM) 918 for storage of instructions and data during program execution and a read only memory (ROM) 920 in which fixed instructions are stored. File storage subsystem 910 provides a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 900 can be of various types including a personal computer, a portable computer, a workstation, a network computer, a mainframe, a kiosk, a server or any other data processing system. Due to the ever-changing nature of computers and networks, the description of computer system 900 depicted in FIG. 9 is intended only as a specific example for purposes of illustrating the preferred embodiment of the computer system. Many other configurations having more or fewer components than the system depicted in FIG. 9 are possible.

The above description makes reference to particular embodiments where the products being sold are electronic devices. This is by way of example, and it is to be understood that embodiments of the invention can be used in any type of sales environment. For example, Employee devices can be used in grocery stores, department stores, gas stations, restaurants (e.g., as menus with dynamic updating to reflect availability of particular dishes, specials, or the like), trade show displays, and any other environment in which products or items of interest are presented to customers. A “product” can include any item, commodity, or service with which an employee device can be associated.

Embodiments of the present invention can be realized using any combination of dedicated components and/or programmable processors and/or other programmable devices. The various processes described herein can be implemented on the same processor or different processors in any combination. Accordingly, where components are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter-process communication, and different pairs of processes may use different techniques, or the same pair of processes may use different techniques at different times. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded on various computer readable storage media; suitable media include magnetic disk or tape, optical storage media such as compact disk (CD) or DVD (digital versatile disk), flash memory, and the like. Computer readable media encoded with the program code may be packaged with a compatible electronic device, or the program code may be provided separately from electronic devices (e.g., via Internet download).

Thus, although the invention has been described with respect to specific embodiments, it will be appreciated that the invention is intended to cover all modifications and equivalents within the scope of the following claims.

What is claimed is:

1. A method for generating an interactive floor map for a store, the method comprising:
receiving, by a computer server, information about a plurality of products being sold in the store;
generating a first interactive floor map for the store, the first interactive floor map displaying a first placement of the plurality of products in the store;
receiving, by the computer server, information about one or more events associated with at least one product from the plurality of products; and
generating, a second interactive floor map based on at least one event from the one or more events, wherein the second interactive floor map displays a second placement of the plurality of products in the store and wherein the second placement is different from the first placement.

2. The method of claim 1 wherein the event occurs at a second time that occurs later than a first time when the first interactive floor map is generated.

3. The method of claim 1 wherein the event corresponds to one or more of:
addition of a new product, change in inventory of the plurality of products, or discontinuation of one or more of the plurality of products.

4. The method of claim 1 wherein the first interactive floor map is associated with a first date and first time and the second interactive floor map is associated with a second date and second time, wherein the second date occurs later than the first date.

5. A method for managing a plurality of retail stores, the method comprising:
generating, at a central server, a first interactive floor map for each of the plurality of retail stores, wherein the first interactive floor map specifies a first arrangement of products to be displayed in the retail store;
communicating, by the central server and for each of the plurality of retail stores, the first interactive floor map to an in-store server or in-store device located in the plurality of retail stores;
receiving, by the central server, information about an event occurring on an effective date and time;
generating, by the central server, based on the information about the event, a second interactive floor map for each of the plurality of retail stores, wherein the second interactive floor map specifies a second arrangement of the products to be displayed in the retail store as of the effective date and time; and
communicating, by the central server to the in-store server or the in-store device, the second interactive floor map in advance of the effective date and time.

6. The method of claim 5 wherein the information about the event includes information about launch of a new product.

7. The method of claim 5 wherein the second arrangement of the products is different from the first arrangement of products.

8. The method of claim 5 wherein the information about the event includes information about a first product that is available for sale on a first effective date and a second product that is available for sale on a second effective date and wherein generating the second interactive floor map further comprises:
providing a first user-selectable indicator for viewing an interactive floor map for a retail store as of the first effective date; and
providing a second user-selectable indicator for viewing an interactive floor map for the retail store as of the second effective date.

9. The method of claim 8 wherein the second effective date occurs after the first effective date and wherein selecting the second user-selectable indicator automatically selects the first user-selectable indicator and wherein a displayed interactive floor map is a combination of the interactive floor map as of the first effective date and the interactive floor map as of the second effective date.

10. A graphical user interface (GUI) comprising:
a first section displaying one or more product display fixtures, the product display fixtures representing one or more products to be displayed in a retail store;
a second section displaying user selectable icons, the user selectable icons including an icon for displaying one or more events associated with the retail store; and
a third section displaying a listing of events associated with the retail store, the third section being activated upon selection of the icon,
wherein the listing of events includes information about one or more products and data and time for each event associated with each of the one or more products.

11. The GUI of claim 10 wherein the third section is a pop-up window and the pop-up window is divided into one or more segments placed adjacent to each other and wherein each segment displays an event in the listing of events and wherein each segment is individually selectable to change information displayed in the first section.

12. The GUI of claim 11 wherein selecting a segment results in automatic selection of another segment immediately adjacent to and preceding the segment.

13. A computer system comprising:
a memory;
a processor coupled to the memory; and
a communication interface coupled to the memory and the processor, the communication interface adapted to communicate with a remote device,
wherein the computer system is adapted to:
receive information about a plurality of products being sold in the store;
generate a first interactive floor map for the store, the first interactive floor map displaying a first placement of the plurality of products in the store;
receive information about one or more events associated with at least one product from the plurality of products; and
generate a second interactive floor map based on at least one event from the one or more events, wherein the second interactive floor map displays a second placement of the plurality of products in the store and wherein the second placement is different from the first placement.

14. The computer server of claim 13 wherein the event occurs at a second time that occurs later than a first time when the first interactive floor map is generated.

15. The computer server of claim 13 wherein the event corresponds to one or more of: addition of a new product, change in inventory of the plurality of products, or discontinuation of one or more of the plurality of products.

16. The computer server of claim 13 wherein the first interactive floor map is associated with a first date and first time and the second interactive floor map is associated with a second date and second time, wherein the second date occurs later than the first date.
